(19) United States
(12) Patent Application Publication
(10) Pub. No.: US 2008/0029212 A1
(43) Pub. Date: Feb. 7, 2008

(54) SLEEVE, SLEEVE UNIT, MOTOR, AND METHOD FOR MANUFACTURING SLEEVE AND SLEEVE UNIT

(75) Inventor: Takehito TAMAOKA, Kyoto (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: NIDEC CORPORATION, Kyoto (JP)

(21) Appl. No.: 11/834,729

(22) Filed: Aug. 7, 2007

(30) Foreign Application Priority Data
Aug. 7, 2006 (JP) 2006-214335

(51) Int. Cl. B29C 65/52; B21K 1/00

(52) U.S. Cl. 156/275.5; 156/281; 156/294; 29/898.02

(57) ABSTRACT

Adhesive is applied to an inner surface of a sleeve housing, and a sleeve is inserted from a lower end part thereof into the sleeve housing. An outer edge of the lower end part of the sleeve is provided with an adhesive holding portion in a chamfered shape, and a part of the adhesive is held between the adhesive holding portion and the inner surface of the sleeve housing.

### BACKGROUND OF THE INVENTION

1. Field of the Invention

The present invention relates to a technique for manufacturing a sleeve unit for a motor, with a sleeve provided in a sleeve housing.

2. Description of Related Art

Conventionally, a data storage disk drive unit such as a hard disk device includes a spindle motor (hereinafter, simply referred to as “motor”) for rotary driving a data storage disk. A bearing assembly utilizing fluid dynamic pressure is adopted as one of motor bearing assemblies. In such a bearing assembly utilizing fluid dynamic pressure, a thrust bearing portion or a radial bearing portion are defined with a shaft, a sleeve to allow the shaft to be inserted thereinto, and the like.

For example, Japanese Unexamined Patent Publication No. 2003-262217 discloses a bearing assembly in which a sleeve is inserted into a sleeve housing and a thrust plate is provided at a distal end of a shaft. This bearing assembly is provided with thrust bearing portions respectively between an upper end surface of the sleeve housing and a lower surface of a rotor hub and between a lower end surface of the sleeve and the thrust plate.

In Japanese Unexamined Patent Publication No. 2006-77872, dynamic pressure grooves are provided respectively in an upper and a lower end surfaces of a sleeve, and thrust bearing portions are provided respectively between the upper end surface of the sleeve and a lower surface of a rotor hub, and between the lower end surface of the sleeve and a thrust plate.

In Japanese Unexamined Patent Publication No. 2004-176816, a sleeve is inserted into a cylindrical sleeve housing having a bottom surface, and is fixed thereto with adhesive.

Japanese Examined Patent Publication No. H07-116490 discloses a technique for sizing a sintered cylindrical member by holding the member between a sizing core having a large diameter in an intermediate portion thereof and a mold, and compressing the held member with upper and lower punches.

Japanese Unexamined Patent Publication No. 10-306827 discloses a technique for sizing and rotary sizing a sintered cylindrical member, and forming a bearing surface thereon. There is disclosed a technique for, in a step of forming the bearing surface, pressing the cylindrical member having a core rod inserted thereinto with a die and upper and lower punches to transfer a pattern of a mold formed on the core rod onto an inner surface of the cylindrical member and thus form dynamic pressure grooves.

An area of the thrust bearing portion located under the rotor hub in the bearing assembly disclosed in Japanese Unexamined Patent Publication No. 2006-77872 is smaller than that in the bearing assembly disclosed in Japanese Unexamined Patent Publication No. 2003-262217.

Further, in the bearing assembly of Japanese Unexamined Patent Publication No. 2006-77872, when the sleeve and a sleeve housing are fixed to each other with adhesive, it is required to prevent adhesive from being adhered to both the upper and lower end surfaces of the sleeve.

In the bearing assembly of Japanese Unexamined Patent Publication No. 2006-77872, force acting from a rotor portion in the motor to the bearing assembly is directly transmitted to the sleeve. However, decrease in amount of adhesive applied to the member deteriorates adhesion force between the sleeve and the sleeve housing and may cause detachment of the sleeve from the sleeve housing.

### SUMMARY OF THE INVENTION

In the preferred embodiments of the present invention, a method of manufacturing a sleeve unit, overcoming the problems described above, is provided.

In the method according to the preferred embodiment of the present invention, the sleeve unit includes a sleeve having a substantially cylindrical body centered a center axis and including an axially first side end surface and an axially second side end surface. The sleeve unit also includes the sleeve housing having a substantially cylindrical body in which the sleeve is accommodated.

The method according to the preferred embodiment of the present invention includes, (a) applying an adhesive to a portion of an inner surface of the sleeve housing, which is to radially oppose an outer surface of the sleeve in the sleeve unit, and (b) inserting the sleeve into the sleeve housing from the axially first side end surface of the sleeve along an axial direction.

Further more, an outer diameter of the sleeve is approximate to an inner diameter of the sleeve housing. The sleeve includes a first connecting surface connecting the axially first end side surface and the outer surface of the sleeve, an outer diameter of the axially first side surface is smaller than a diameter of the outer surface of the sleeve. A portion of the adhesive is spread along the inner surface of the sleeve housing, and the other portion of the adhesive is held on the first connecting surface and between the first connecting surface and the inner surface of the sleeve housing in the step (b).

In the method according to the other preferred embodiment of the present invention, the sleeve unit includes a sleeve having a substantially cylindrical body centered a center axis and including an axially first side end surface and an axially second side end surface. The sleeve unit also includes the sleeve housing having a substantially cylindrical body in which the sleeve is accommodated.

The method according to the other preferred embodiment of the present invention includes, (a) applying an adhesive to a portion of an outer surface of the sleeve, which is to radially oppose an inner surface of the sleeve housing in the sleeve unit, and (b) inserting the sleeve into the sleeve housing from the axially second side end surface of the sleeve along an axial direction.

Further more, an outer diameter of the sleeve is approximate to an inner diameter of the sleeve housing. The sleeve includes a first connecting surface connecting the axially first end side surface and the outer surface of the sleeve, an outer diameter of the axially first side surface is smaller than a diameter of the outer surface of the sleeve. A portion of the adhesive is spread along the inner surface of the sleeve housing, and the other portion of the adhesive is held on the first connecting surface and between the first connecting surface and the inner surface of the sleeve housing in the step (b).

According to the preferred embodiment of the present invention, it is possible to prevent the adhesive from adhering to the end surface of the sleeve facing the rotor hub, and to secure a large area for the end surface. Therefore, the sleeve and the sleeve housing can be fixed to each other with no deterioration in performance of a thrust bearing portion provided between the rotor hub and the end surface of the sleeve.

According to another preferred embodiment of the present invention, a sleeve unit used for a motor having a rotor hub rotatable about the center axis includes a sleeve having a cylindrical shape and including an axially first side end surface arranged in an axially first side. An axially second side end surface arranged in an axially second side which is an axially opposite side of the axially first side. The sleeve also includes a first connecting surface connecting an outer surface and the first axial surface having an outer diameter smaller than that of the outer surface, and a second connecting surface connecting the outer surface and the second axial surface having an outer diameter smaller than that of the outer surface. The sleeve unit further includes a sleeve housing accommodating the sleeve and having an inner surface to which the outer surface of the sleeve is attached, and an adhesive a portion of which is arranged between the inner surface of the sleeve housing and the outer surface of the sleeve.

In the preferred embodiment of the present invention, an adhesive holding portion is defined between the first connecting surface and the inner surface of the sleeve housing, and a portion of the adhesive is held in the adhesive holding portion.

The adhesive arranged in the adhesive holding portion functions as a wedge and prevents the sleeve from being displaced with respect to the sleeve housing even when heavy downward load is applied to the sleeve. That is, the adhesive arranged in the adhesive holding portion prevents destruction of adhesive joining between the sleeve and the sleeve housing.

### BRIEF DESCRIPTION OF THE DRAWINGS

FIG. 1 is a cross sectional view of a motor;

FIG. 2 is a cross sectional view of a sleeve unit;

FIG. 3A is a plan view of a sleeve;

FIG. 3B is a cross sectional view of the sleeve;

FIG. 3C is a bottom plan view of the sleeve;

FIG. 4A is a cross sectional view illustrating an example of an adhesive holding portion;

FIG. 4B is a cross sectional view illustrating another example of the adhesive holding portion;

FIG. 5 is a chart illustrating example of process flow of manufacturing the sleeve unit;

FIG. 6 is a view illustrating the sleeve unit in course of manufacturing;

FIG. 7 is another view illustrating the sleeve unit in course of manufacturing;

FIG. 8 is a chart illustrating another example of process flow of manufacturing the sleeve unit;

FIG. 9 is still another view illustrating the sleeve unit in course of manufacturing;

FIG. 10 is still further another view illustrating the sleeve unit in course of manufacturing;

FIG. 11 is a chart illustrating still another process flow of manufacturing the sleeve;

FIG. 12 is a view illustrating the sleeve in course of manufacturing;

FIG. 13A is another view illustrating the sleeve in course of manufacturing;

FIG. 13B is still another view illustrating the sleeve in course of manufacture;

FIG. 13C is still further another view illustrating the sleeve in course of manufacture; and

FIG. 14 is a chart illustrating further another example of process flow of manufacturing the sleeve.

### DETAILED DESCRIPTION OF THE PREFERRED EMBODIMENTS

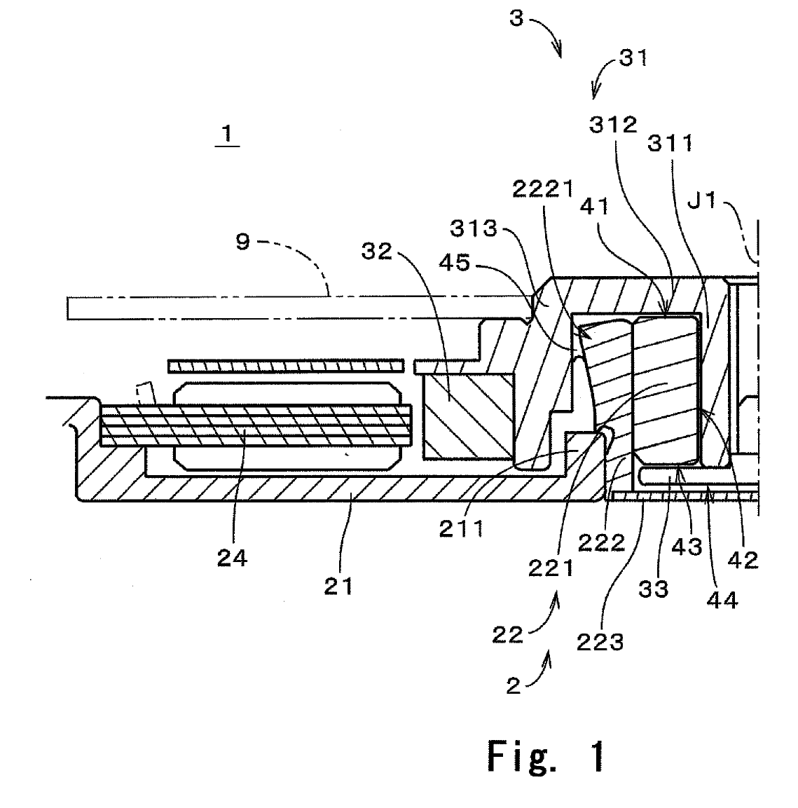

FIG. 1 is a vertical cross sectional view of a motor 1 for driving a data storage disk according to a preferred embodiment of the present invention. FIG. 1 illustrates only a left half of a cross section of the motor 1 including a central axis J1 (which is also a central axis of a sleeve unit 22 to be described later).

The motor 1 includes a static portion 2 as a stator assembly and a rotor portion 3. The rotor portion 3 is supported by the static portion 2 via a bearing assembly utilizing fluid dynamic pressure of lubricant so as to rotate around the central axis J1. It is noted that, in the description of the present invention, positional relations and directions of respective members described as up, down, left, and right simply indicate positional relations and directions in the drawings, and do not indicate positional relations and directions when actually incorporated in equipment.

The rotor portion 3 includes a rotor hub 31 and a rotor magnet 32. A center of the rotor hub 31 is connected with a shaft 311 extending downwards from the rotor hub 31. The rotor magnet 32 is attached to the rotor hub 31 and arranged around the central axis J1. The rotor hub 31 and the shaft 311 are formed as a single member made of stainless steel and the like.

The rotor hub 31 includes a discoid portion 312 in a substantially circular disk shape and a cylindrical portion 313 in a substantially cylindrical shape. The discoid portion 312 extends perpendicularly to the central axis J1 from an upper end part of the shaft 311. The cylindrical portion 313 projects downwards from an outer edge of the discoid portion 312. A thrust plate 33 in a substantially circular disk shape is attached to a lower distal end of the shaft 311. A data storage disk 9 is set on an upper surface of the rotor hub 31 as indicated with chain double-dashed line.

The static portion 2 includes a base plate 21 serving as a base portion for supporting each part of the static portion 2, a sleeve unit 22 in a substantially cylindrical shape, and an armature 24. The shaft 311 is inserted into the sleeve unit 22. The armature 24 is attached to the base plate 21 around the sleeve unit 22.

The armature 24 is attached to the base plate 21 from an upper side by press fitting or adhesive joining, and torque around the central axis J1 is generated between the armature 24 and the rotor magnet 32 arranged around the shaft 311. In other words, the armature 24 and the rotor magnet 32 function as a drive mechanism for rotating the rotor portion 3 with respect to the static portion 2.

At a center of the base plate 21, there is provided a sleeve attaching portion 211 having a substantially cylindrical shape and projecting upwards around the central axis J1. The sleeve unit 22 includes a sleeve 221, a sleeve housing 222 in a substantially cylindrical shape as a sleeve supporting member, and a seal cap 223 in a substantially circular disk shape, and is inserted into the sleeve attaching portion 211 and fixed with adhesive to the base plate 21. The sleeve 221 is formed into a substantially cylindrical shape around the central axis J1. The sleeve housing 222 is attached to an outer surface of the sleeve 221. The seal cap 223 seals an opening at a lower side of the sleeve housing 222. Alternatively, the sleeve housing 222 and the seal cap 223 may be formed as a single member. In this case, the sleeve housing is formed into a cylindrical shape having a bottom surface.

At an upper part of the sleeve housing 222, there is formed a flange portion 2221 projecting radially outwards along an outer periphery of the sleeve unit 22. When the sleeve unit 22 is attached to the base plate 21, a lower part of the flange portion 2221 and an upper end part of the sleeve attaching portion 211 come in contact to each other.

The motor 1 is formed with microscopic spaces including an upper space 41, a side space 42, a first lower space 43, a second lower space 44, and an outer space 45.

The upper space 41 is formed between a lower surface of the discoid portion 312 of the rotor hub 31 and an upper end surface of the sleeve 221. The side space 42 is formed between an inner surface of the sleeve 221 and an outer surface of the shaft 311. The first lower space 43 is formed between a lower surface of the sleeve 221 and an upper surface of the thrust plate 33. The second lower space 44 is formed between a lower surface of the thrust plate 33 and an upper surface of the seal cap 223. The outer space 45 is formed between an outer surface of the flange portion 2221 of the sleeve housing 222 and an inner surface of the cylindrical portion 313 of the rotor hub 31.

The outer surface of the flange portion 2221 is inclined such that an outer diameter thereof is gradually decreased toward a lower side. An interface of lubricant in the outer space 45 is formed into a meniscus shape due to capillarity and surface tensity, defining a taper seal in the outer space 45. According to such a configuration, the outer space 45 functions as an oil buffer to prevent the lubricant from flowing outwards.

On the other hand, upper and lower end surfaces of the sleeve 221 are respectively formed with upper and lower thrust dynamic pressure groove arrays for generating fluid dynamic pressure in the lubricant due to rotation of the rotor portion 3, so that thrust dynamic pressure bearing portions are formed in the first lower space 43 and the upper space 41. Alternatively, the lower surface of the thrust plate or the upper surface of the seal cap may be provided with the dynamic pressure groove array to form the thrust dynamic pressure bearing portion in the second lower space. Further, the inner surface of the sleeve 221 is formed with a radial dynamic pressure groove array for generating fluid dynamic pressure in the lubricant in the side space 42, so that a radial dynamic pressure bearing portion is formed in the side space 42.

As described above, in the motor 1, the sleeve unit 22, the seal cap 223, the shaft 311, the discoid portion 312 and the thrust plate 33 (as well as the lubricant) form the bearing assembly utilizing fluid dynamic pressure. Since the bearing assembly contactlessly supports the rotor portion 3 via the lubricant, the rotor portion 3 and the data storage disk 9 can be rotated highly accurately and quietly. Particularly, the bearing assembly in which the upper space 41, the side space 42, the first lower space 43, the second lower space 44, and the outer space 45 are continuously filled with lubricant can further suppress unusual contact between the shaft 311 and the sleeve 221 due to bubbles generated in the lubricant, leakage of the lubricant due to expansion of air in the bearing assembly.

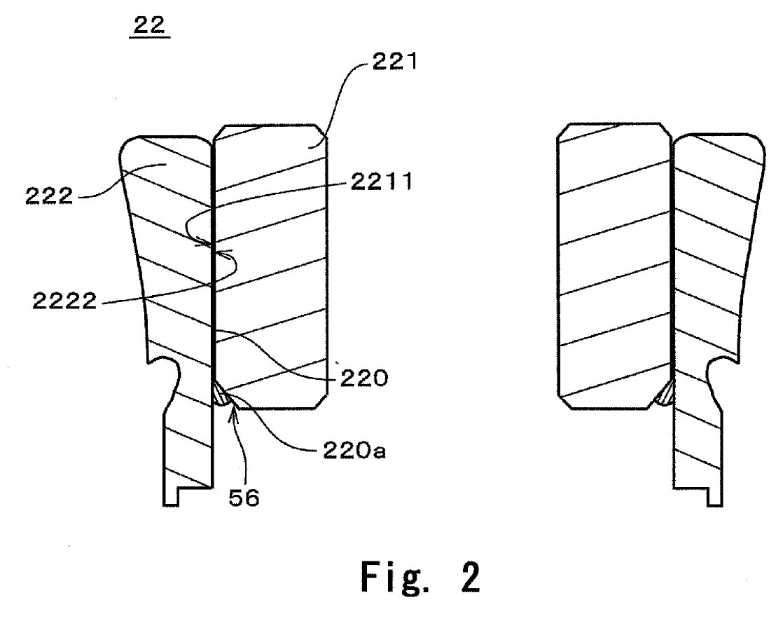

FIG. 2 is an enlarged cross sectional view of the sleeve unit 22 (except for the seal cap 223). The sleeve 221 may be inserted into the sleeve housing 222 with a slight space from an inner surface 2222 of the sleeve housing 222 (e.g., about 0 .mu.m˜about 5 .mu.m), that is, running fitted. Alternatively, the sleeve 221 may be interference fitted into the sleeve housing 222. In this case, the outer diameter of the sleeve 221 is from about 5 .mu.m to about 50 .mu.m greater than the inner diameter of the sleeve housing 222 (e.g., an overlapping width of the sleeve housing 222 and the sleeve 221 is from about 5 .mu.m to about 50 .mu.m). It should be noted, as stated above, the outer diameter of the sleeve 221 and the inner diameter of the sleeve housing 222 may be substantially the same or may be slightly different from each other. For the convenience of illustrating, the outer diameter of the sleeve 221 and the inner diameter of the sleeve housing 222 will be described as “approximate” in order to describe the variation in size thereof. Meanwhile, the overlapping width or the gap between the sleeve housing 222 and the sleeve 221 may be preferably adjusted in accordance with the material of the sleeve housing 222.

After the sleeve 221 is inserted into the sleeve housing 222, the sleeve 221 is fixed to the sleeve housing 222 with adhesive 220 interposing between the inner surface 2222 of the sleeve housing 222 and an outer surface 2211 of the sleeve 221.

An outer peripheral edge at a lower end part of the sleeve 221 is chamfered to form an adhesive holding portion 56 to be described later. Adhesive 220a is held between the adhesive holding portion 56 and the inner surface 2222 of the sleeve housing 222 continuously from between the sleeve housing 222 and the sleeve 221. On the other hand, the adhesive 220 is merely held between an upper end part of the sleeve 221 and the sleeve housing 222.

The adhesive 220a functions as a wedge and prevents the sleeve 221 from being displaced with respect to the sleeve housing 222 even when heavy downward load is applied to the sleeve 221 via the rotor hub 31. That is, the adhesive 220a prevents destruction of adhesive joining between the sleeve 221 and the sleeve housing 222.

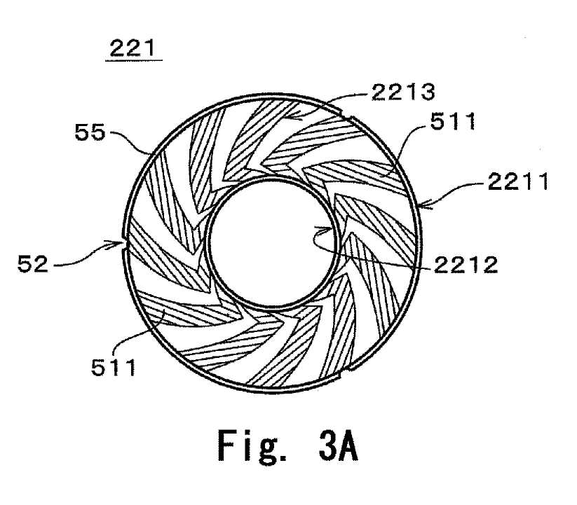

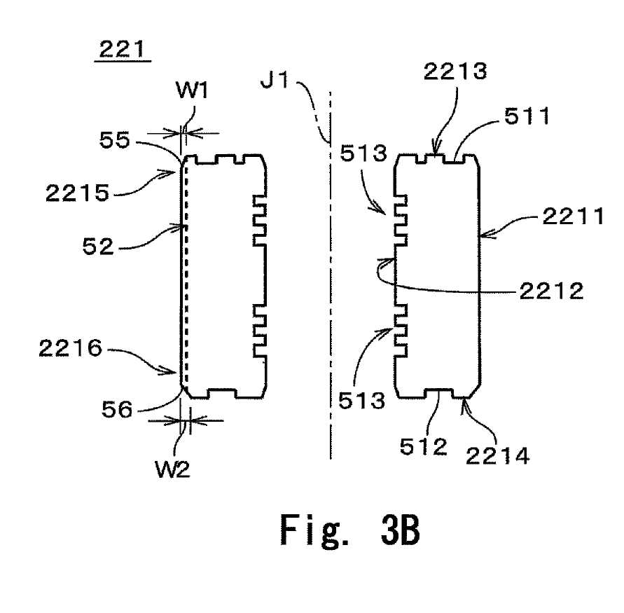

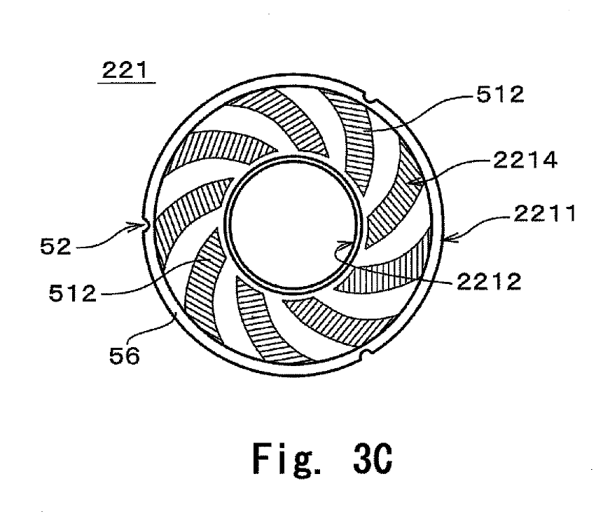

FIGS. 3A to 3C are respectively a plan view, a vertical cross sectional view, and a bottom plan view of the sleeve 221. In FIGS. 3A and 3C, the upper and lower thrust dynamic pressure groove arrays are marked with parallel diagonal lines, while in FIG. 3B, parallel diagonal lines for representing the cross section are not illustrated. Further, in FIG. 3B, the upper and lower thrust dynamic pressure groove arrays and the radial dynamic pressure groove arrays are emphatically illustrated.

Each of the outer surface 2211 and the inner surface 2212 of the sleeve 221 has a substantially cylindrical shape. On an upper end surface 2213 connecting an upper end of the outer surface 2211 and an upper end of the inner surface 2212 of the sleeve 221, and on a lower end surface 2214 connecting a lower end of the outer surface 2211 and a lower end of the inner surface 2212, dynamic pressure grooves as a group of grooves are respectively formed. Dynamic pressure grooves 511 on the upper end surface 2213 are formed into a herringbone shape, and dynamic pressure grooves 512 on the lower end surface 2214 are formed into a spiral shape.

Further, dynamic pressure grooves 513 in a herringbone shape are formed at upper and lower parts on the inner surface 2212 of the sleeve 221, and three communicating grooves 52 extending along the central axis J1 are formed on the outer surface 2211 while equiangularly spaced apart from one another. The communicating grooves 52 reduce difference in pressure between the upper space 41 and the first lower space 43 illustrated in FIG. 1 to prevent generation of bubbles in the bearing assembly.

As illustrated in FIG. 3B, an outer peripheral edge and an inner peripheral edge of an upper end portion 2215 (hereinafter, referred to as “first end portion”) to face the rotor hub 31 of the sleeve 221 are chamfered to have liner cross sections. An outer peripheral edge and an inner peripheral edge of a lower end portion 2216 (hereinafter, referred to as “second end portion”) arranged an axially opposite side of the first end portion 2215 are also chamfered to have liner cross sections. Angles between the respective chamfered shapes and the central axis J1 may be arbitrarily set. A radial width W1 of a chamfered end 55 formed by chamfering the outer peripheral edge of the first end portion 2215 is smaller than a radial width W2 of the adhesive holding portion 56 formed by chamfering the outer peripheral edge of the second end portion 2216. As illustrated in FIG. 2, the adhesive holding portion 56 holds the partial adhesive 220a. More specifically, a width in the direction of the central axis J1 and the width in the radial direction of the adhesive holding portion 56 are set to be twice larger than the width in the direction of the central axis J1 and the width in the radial direction of the chamfered end 55, respectively.

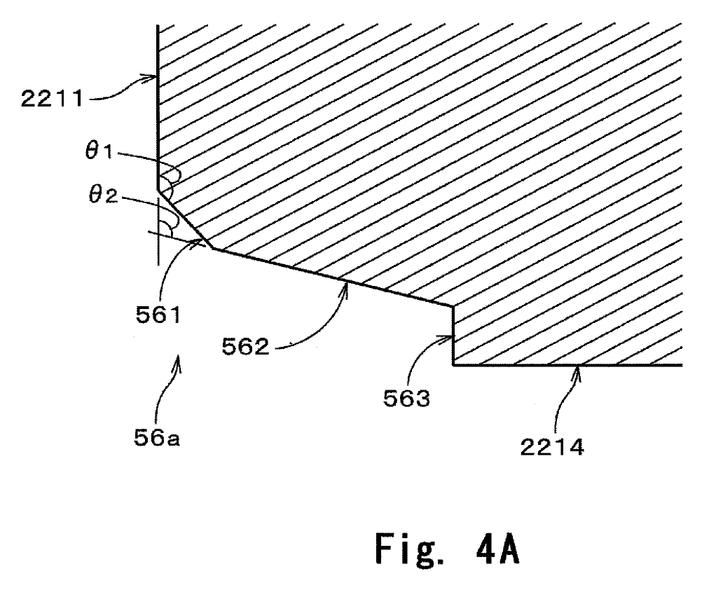

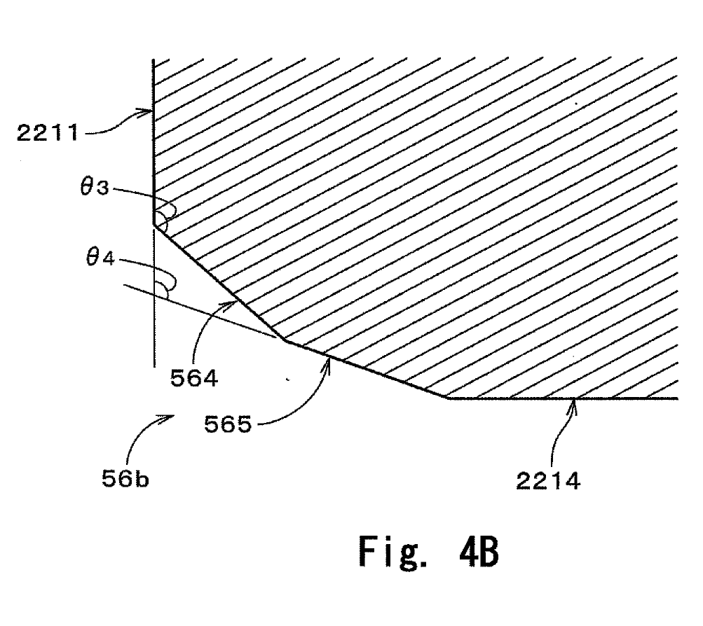

FIG. 4A is a cross sectional view illustrating modified example of the adhesive holding portion. An adhesive holding portion 56a illustrated in FIG. 4A includes a circular surface (in a circular truncated cone shape) connecting to the outer surface 2211 and forming a first obtuse angle q° (which is an angle on the side of the central axis J1) with the outer surface 2211 in a cross section including the central axis J1 (hereinafter the circular surface is referred to as a first inclined surface 561). The adhesive holding portion 56a also includes another circular surface (in a circular truncated cone shape) connecting to an inner side of the first inclined surface 561 and forming a second obtuse angle q° (which is an angle on the side of the central axis J1), which is smaller than the first obtuse angle q°, with the outer surface 2211 in the cross section (hereinafter another circular surface is referred to as a second inclined surface 562). The adhesive holding portion 56a further includes a cylindrical surface 563 extending along the central axis J1, connecting an inner side of the second inclined surface 562 and the lower end surface 2214.

As illustrated in FIG. 4A, when the two inclined surfaces 561 and 562 are provided, the adhesive, which is held by the adhesive holding portion 56a due to the first inclined surface 561 forming a small angle with the central axis J1, efficiently functions as a wedge and joint strength between the sleeve and sleeve housing is increased (see FIG. 2). Therefore, more adhesive can be held by the adhesive holding portion 56a due to the second inclined surface 562 forming a large angle with the central axis J1. In a case of the adhesive holding portion 56a illustrated in FIG. 4A, much more adhesive can be held due to the cylindrical surface 563.

FIG. 4B is a cross sectional view illustrating still another example of the adhesive holding portion. An adhesive holding portion 56b illustrated in FIG. 4B includes a circular surface connecting to the outer surface 2211 and forming a first obtuse angle q° with the outer surface 2211 in a cross section including the central axis J1 (hereinafter a first inclined surface 564 illustrated in FIG. 4A is referred to as a first inclined surface 564), and another circular surface in contact with an inner side of the first inclined surface 564 and the lower end surface 2214 and forming a second obtuse angle q°, which is smaller than the first obtuse angle q°, with the outer surface 2211 in the cross section (hereinafter the another circular surface illustrated in FIG. 4B is simply referred to as a second inclined surface 565). Also in the adhesive holding portion 56b illustrated in FIG. 4B, the adhesive efficiently functions as the wedge due to the first inclined surface 564, and more adhesive can be held by the adhesive holding portion 56b due to the second inclined surface 565.

It is alternatively possible to adopt a different adhesive holding portion in a so called stepped shape formed by a combination of a circular surface extending inwards from and perpendicularly to the outer surface 2211 and a cylindrical surface connecting an inner side of the circular surface and the lower end surface 2214.

The adhesive holding portion such as those illustrated in FIGS. 2, 4A, and 4B has, for example, the width in the direction of the central axis J1 of 0.15 to 0.3 mm and the radial width of 0.15 to 0.3 mm when the sleeve 221 has a diameter of approximately 4 mm.

As described above, the adhesive holding portion may have various shapes as far as the outer peripheral edge of the second end portion 2216 has a surface connecting the outer surface 2211 and the end surface (lower end surface) 2214 having a diameter smaller than that of the outer surface 2211.

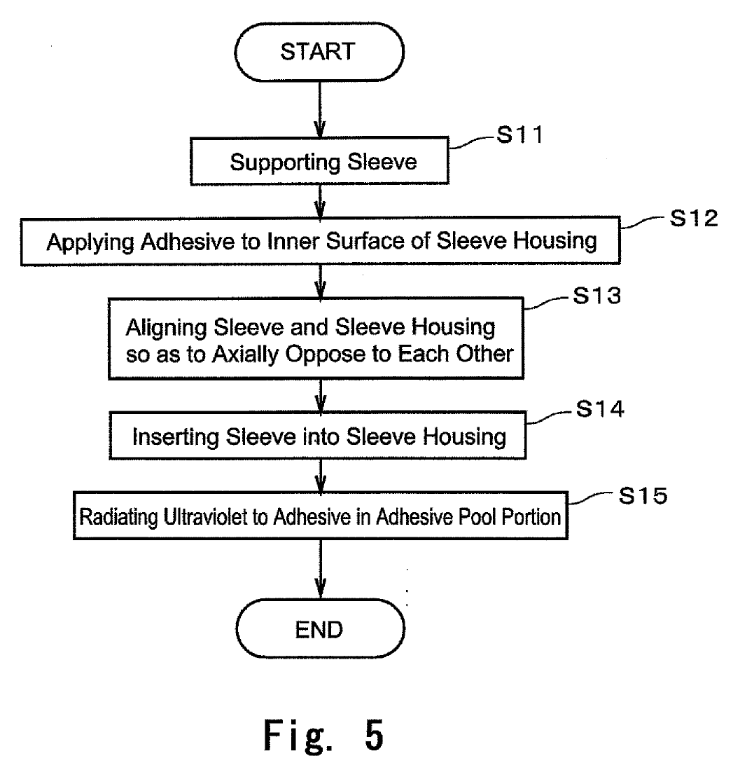

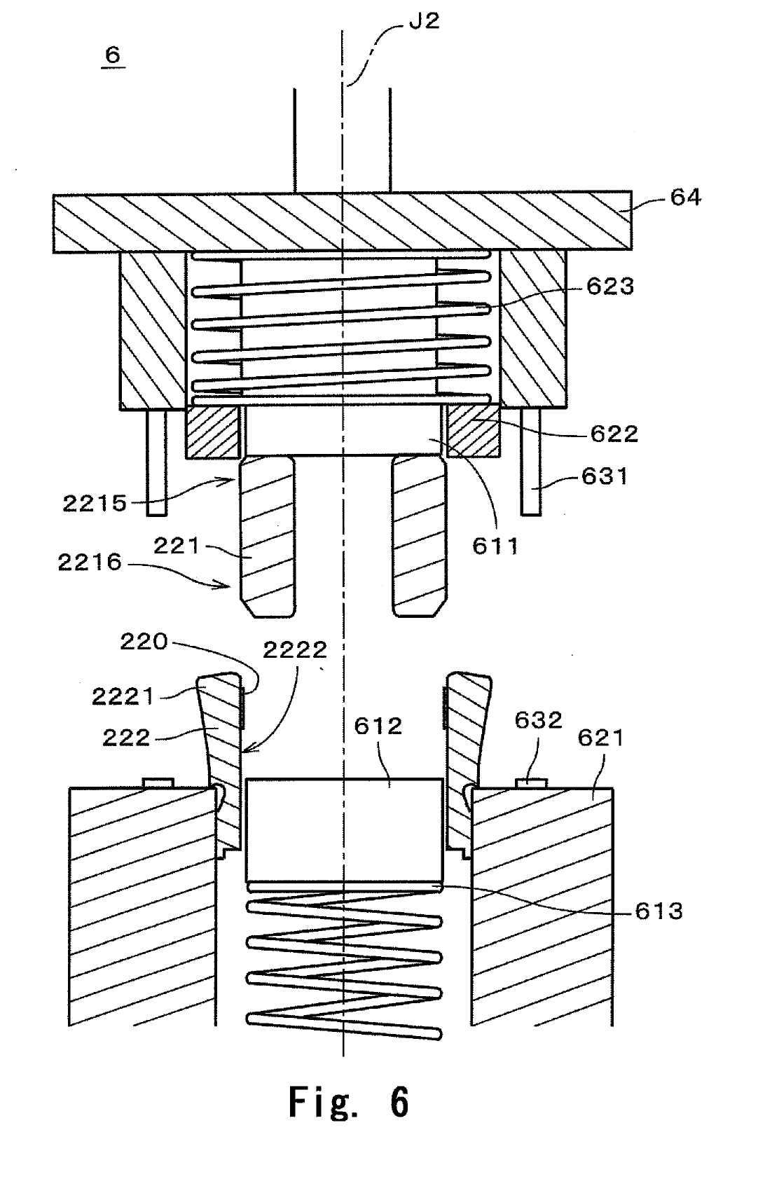

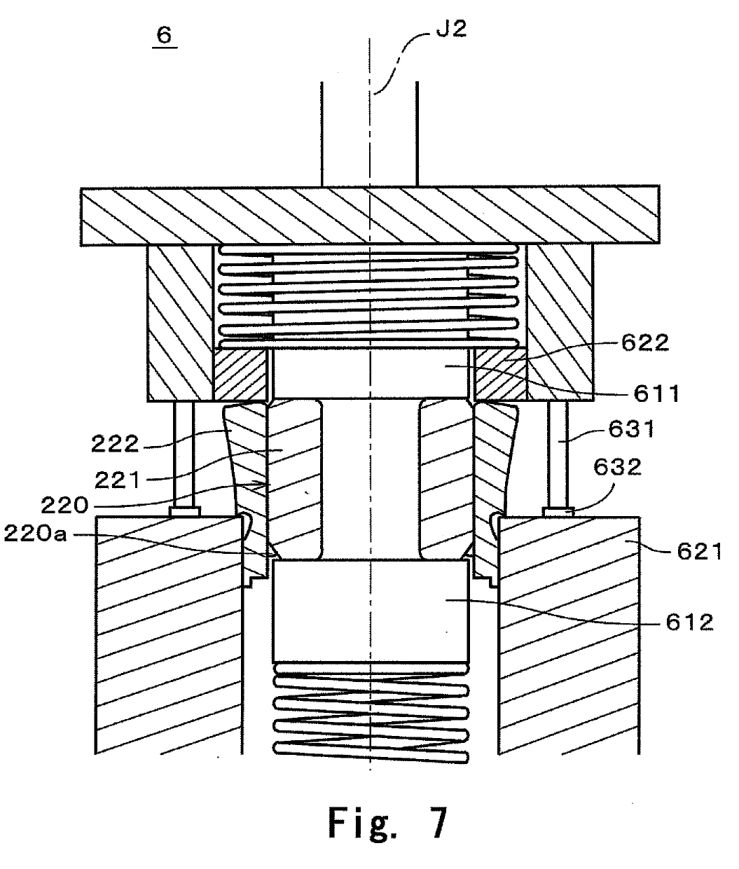

FIG. 5 is a chart illustrating flow of manufacturing the sleeve unit 22 (except for the seal cap 223), and FIGS. 6 and 7 are views illustrating manufacture of the sleeve unit 22 with a sleeve unit assembly device 6. In order to manufacture the sleeve unit 22, as illustrated in FIG. 6, the first end portion 2215 of the sleeve 221 is firstly adsorbed from an upper side, so that the sleeve 221 is held by the sleeve holding portion 611 (step S11). Then, the anaerobic and ultraviolet curing adhesive 220 is applied to the inner surface 2222 of the sleeve housing 222 (step S12), and the sleeve housing 222 is supported on a housing holding portion 621 to be engaged with the lower part of the flange portion 2221 while facing the second end portion 2216 of the sleeve 221. In this step, the sleeve 221 and the sleeve housing 222 are held such that centers thereof are aligned with a central axis J2 of the sleeve unit assembly device 6 (step S13).

Below the sleeve 221, a first biasing portion 612 is attached to a lower supporting portion (not illustrated) via a first coil spring 613. Above the sleeve housing 222, a second biasing portion 622 radially surrounding the sleeve holding portion 611 is attached to an upper supporting portion 64 via a second coil spring 623. A downward pin 631 is indirectly fixed to the upper supporting portion 64 via a block, and a pin contacting portion 632 facing the pin 631 is fixed onto the housing holding portion 621.

After the sleeve 221 and the sleeve housing 222 are arranged to the sleeve holding portion 611 and the housing holding portion 621, the upper supporting portion 64 then descends such that the sleeve holding portion 611 is brought closer to the housing holding portion 621, and the sleeve 221 is inserted into the sleeve housing 222 from the second end portion 2216 (step S14).

In course of insertion, the second end portion 2216 of the sleeve 221 is brought into contact with the first biasing portion 612, and the first coil spring 613 is elastically deformed so that the sleeve 221 is biased by the first biasing portion 612 toward the sleeve holding portion 611. After the sleeve 221 has contacted the first biasing portion 612, adsorption of the sleeve 221 by the sleeve holding portion 611 may be halted.

At the same time, in course of inserting the sleeve 221, the upper part of the sleeve housing 222 is brought into contact with the second biasing portion 622, so that the second coil spring 623 is elastically deformed and the sleeve housing 222 is biased toward the housing holding portion 621.

Then, as illustrated in FIG. 7, when a distal end of the pin 631 contacts the pin contacting portion 632, insertion of the sleeve 221 into the sleeve housing 222 is halted. Accordingly, a relative position of the housing holding portion 621 with respect to the sleeve holding portion 611 is accurately determined, and relative positions in the direction of the central axis J2 of the sleeve 221 in contact with the sleeve holding portion 611 and the sleeve housing 222 in contact with the housing holding portion 621 are accurately determined.

During insertion, the adhesive 220 is spread by the second end portion 2216 of the sleeve 221 such that the adhesive is held between the outer surface of the sleeve 221 and the inner surface of the sleeve housing 222. As illustrated in FIG. 2, the partial adhesive 220a pushed out (also illustrated in FIG. 7) is held between the adhesive holding portion 56 of the sleeve 221 and the inner surface 2222 of the sleeve housing 222. The amount of the adhesive 220 to be applied in step S12 is predetermined such that the pushed out adhesive 220a is appropriate in amount while variation in applied amount is taken into consideration.

Thereafter, the sleeve 221 and the sleeve housing 222 are held for a predetermined period of time (such as for two minutes), and the anaerobic adhesive 220 not in contact with atmosphere is cured between the outer surface of the sleeve 221 and the inner surface of the sleeve housing 222, so that the sleeve 221 is fixed to the sleeve housing 222.

On completion of fixation, the sleeve holding portion 611 and the housing holding portion 621 are separated from each other, and the sleeve 221 and the sleeve housing 222 are taken out. The adhesive 220a held in the adhesive holding portion 56, that is, exposed, is irradiated with ultraviolet and cured, completing manufacture of the essential part of the sleeve unit 22 (step S15).

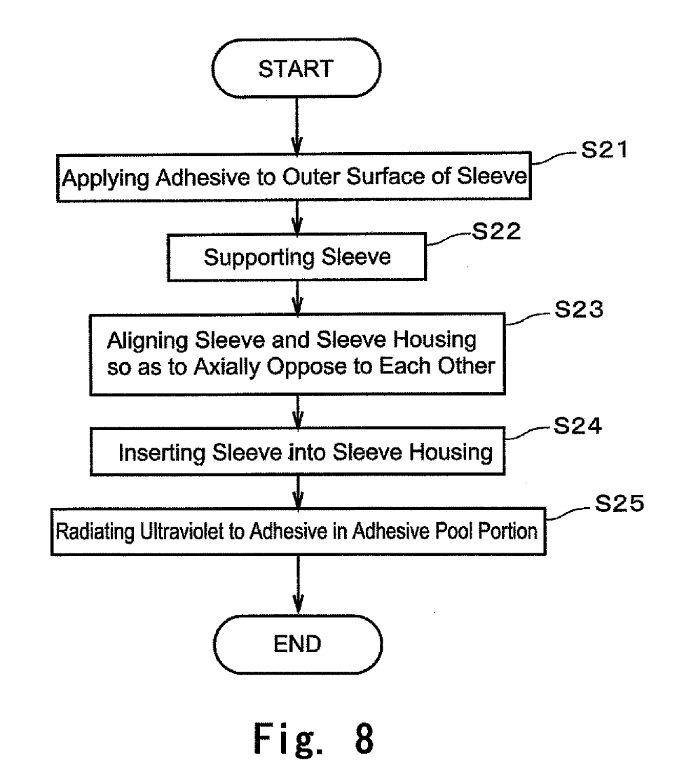

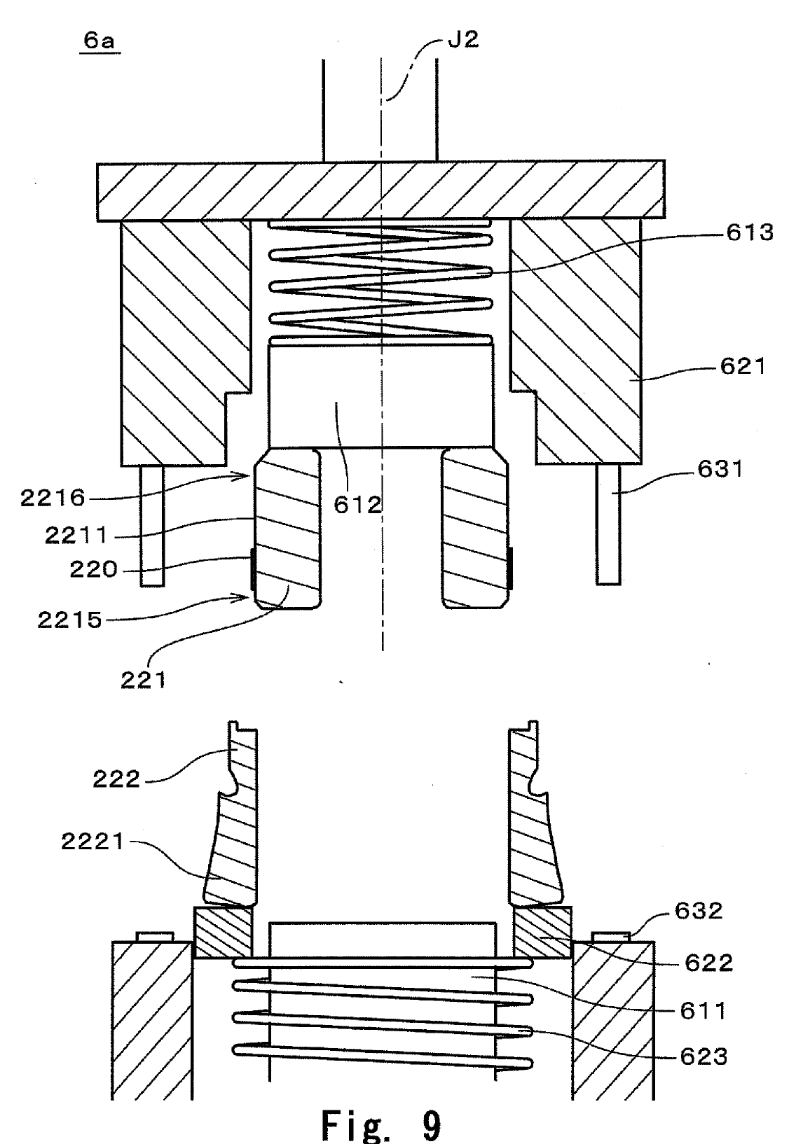

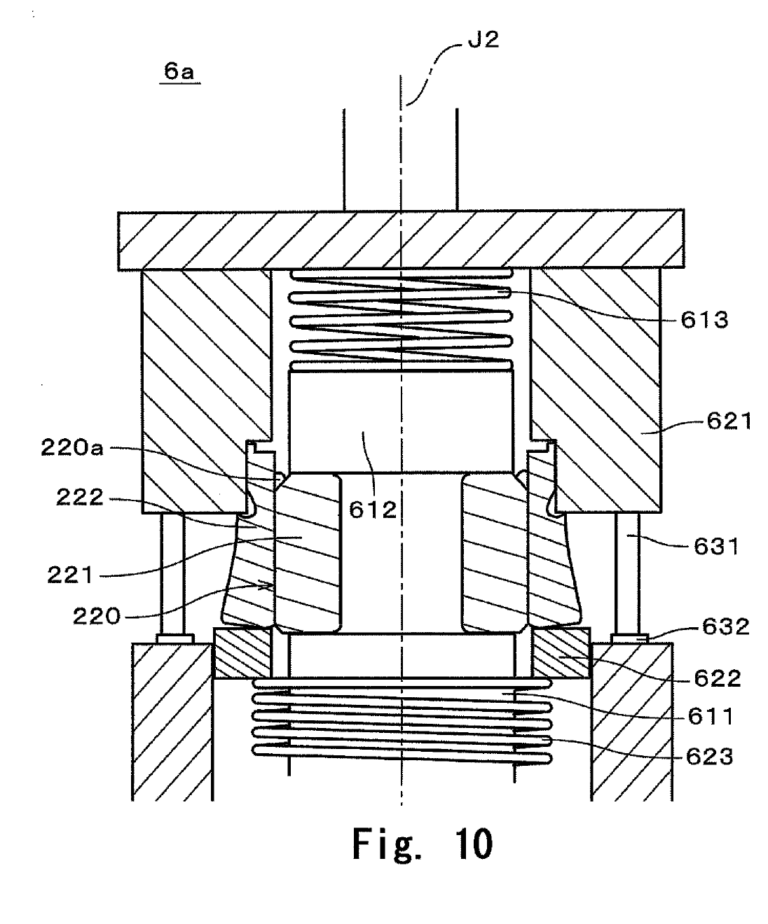

FIG. 8 is a chart illustrating another example of process flow of manufacturing the sleeve unit 22, and FIGS. 9 and 10 are views illustrating manufacture of the sleeve unit 22. In FIGS. 9 and 10, vertical relations of the sleeve 221 and the sleeve housing 222 are reversed from the case of FIGS. 6 and 7. A sleeve unit assembly device 6a is obtained by vertically reversing the device of FIG. 6 except for the pin 631 and the pin contacting portion 632, and is also different from the device of FIG. 6 in shapes of some of the parts. In FIGS. 9 and 10, identical reference symbols are designated to constituents similar to those of FIG. 6. However, since the constituents corresponding to the sleeve holding portion 611 and the housing holding portion 621 in FIG. 6 merely contact the sleeve 221 and the sleeve housing 222 respectively, the sleeve holding portion 611 and the housing holding portion 621 are referred to as “sleeve contacting portion 611” and “housing contacting portion 621” in the following description. The first biasing portion 612 is provided with a function of adsorbing and holding the sleeve 221.

First, the anaerobic and ultraviolet curing adhesive 220 is applied to the outer surface 2211 of the sleeve 221 (step S21), and as illustrated in FIG. 9, the second end portion 2216 of the sleeve 221 is adsorbed from an upper side such that the sleeve 221 is held by the first biasing portion 612 (step S22). Then, the sleeve housing 222 is held by the second biasing portion 622 with the flange portion 2221 directed downwards, that is, a portion opposite to the flange portion 2221 facing the first end portion 2215 of the sleeve 221 (step S23).

Subsequently, in a state where the center of the sleeve 221 and the center of the sleeve housing 222 are aligned with the central axis J2 of the sleeve unit assembly device 6a, the sleeve contacting portion 611 is brought closer to the housing contacting portion 621, and the sleeve 221 is inserted from the first end portion 2215 into the sleeve housing 222 (step S24).

When the sleeve contacting portion 611 is brought closer to the housing contacting portion 621 and the pin 631 contacts the pin contacting portion 632, as illustrated in FIG. 10 and similarly to FIGS. 6 and 7, the sleeve 221 is held between the sleeve contacting portion 611 and the first biasing portion 612 due to the first coil spring 613, and the sleeve housing 222 is held between the housing contacting portion 621 and the second biasing portion 622 due to the second coil spring 623, thereby accurately determining the relative positions in the direction of the central axis J2 of the sleeve 221 and the sleeve housing 222.

In course of insertion, while the adhesive 220 is held between the outer surface of the sleeve 221 and the inner surface of the sleeve housing 222 and spread by a thinner part (upper part in FIG. 10) of the sleeve housing 222, so that a portion of the adhesive 220 is disposed between the inner surface of the sleeve housing 222 and the outer surface of the sleeve 221, as illustrated in FIG. 2, the partial adhesive 220a pushed out (also illustrated in FIG. 10) is held between the adhesive holding portion 56 of the sleeve 221 and the inner surface 2222 of the sleeve housing 222.

Thereafter, the sleeve 221 and the sleeve housing 222 are held for a predetermined period of time, and the adhesive 220 not in contact with atmosphere is cured while the adhesive 220a exposed on the adhesive holding portion 56 is cured by irradiation of ultraviolet (step S25).

In the two methods for manufacturing the sleeve unit 22 described above, the adhesive 220a is held by the adhesive holding portion 56, and the position of the adhesive 220 to be applied and the direction of the sleeve 221 to be inserted are determined such that the adhesive 220 is not pushed out to the side of the first end portion 2215, thereby preventing deterioration in performance of the thrust bearing portion in the upper space 41 illustrated in FIG. 1 due to adhesion of the adhesive 220 to the upper end surface 2213. Moreover, it is possible to increase the amount of the adhesive to be applied without requiring work of removing the adhesive and to prevent contact of the adhesive with the thrust plate 33. Therefore, adhesive strength can be easily increased while preventing deterioration in performance of the thrust bearing portion around the thrust plate 33.

Since the space between the thrust plate 33 and the inner peripheral surface of the sleeve housing 222 is relatively made large, the adhesive merely affects the thrust bearing portions in the first lower space 43 and the second lower space 44 even if the adhesive 220a is spread from the adhesive holding portion 56 toward the sleeve housing 222.

As the chamfered shape at the outer peripheral edge of the first end portion 2215 can be made small, an area of the upper end surface 2213 of the sleeve 221 can be made large and the dynamic pressure can be maintained to be high. Further, the dynamic pressure grooves can be formed into the herringbone shape due to a large dynamic pressure surface, realizing further increased performance of the thrust bearing portion (in the upper space 41).

As already described, because the partial adhesive 220a held by the adhesive holding portion 56 functions as the wedge, joint strength between the sleeve 221 and the sleeve housing 222 can be increased against force such as impact from the thrust direction applied from the rotor portion 3 to the sleeve 221. As a result, length of fastening the sleeve 221 and the sleeve housing 222 in the direction of the central axis J1 can be made shorter, thereby realizing a thinner motor 1.

As the anaerobic and ultraviolet curing adhesive 220 is used in manufacture of the sleeve unit 22, it is possible to easily cure the adhesive held in the space between the sleeve 221 and the sleeve housing 222 as well as the adhesive pushed out of the space, thereby simplifying the manufacture of the sleeve unit 22. Alternatively, the adhesive 220 may be used which has thermosetting property, ultraviolet curing and thermosetting properties, or anaerobic, ultraviolet curing and thermosetting properties. Even if the adhesive 220 with ultraviolet curing property does not have anaerobic property, the adhesive 220 can be tentatively cured by ultraviolet and then further cured in course of time, realizing manufacture without deterioration in tact. In addition, use of the adhesive including a large amount of epoxy further increases adhesive strength.

Since the sleeve 221 is attached to the sleeve housing 222 by running fitting in manufacture of the sleeve unit 22, it is possible to prevent strong friction between the outer surface 2211 of the sleeve 221 and the inner surface 2222 of the sleeve housing 222 during insertion of the sleeve 221. Therefore, deformation of the dynamic pressure surface of the sleeve 221 is prevented. Thus, the technique of fixing the sleeve 221 and the sleeve housing 222 with adhesive according to the preferred embodiments of the present invention is suited particularly for a case where the sleeve 221 is made of porous material such as a sinter, which is relatively weaker than solid material.

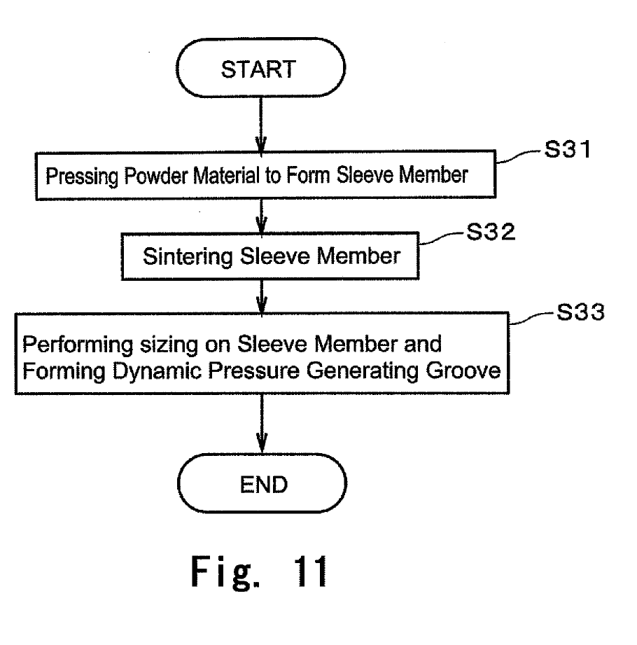

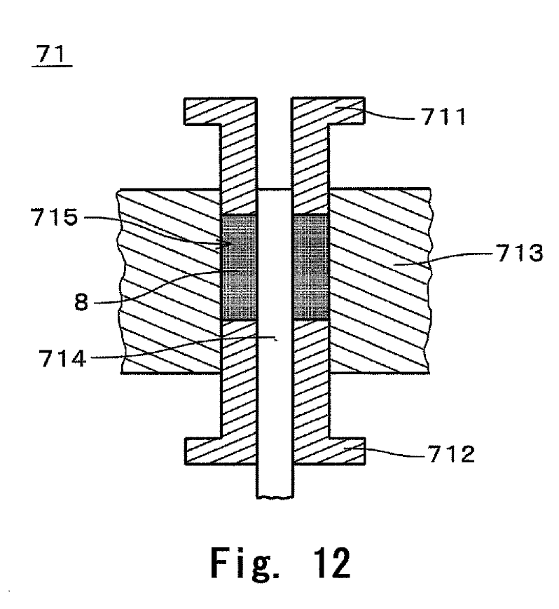

Manufacture of the sleeve 221 is described below. FIG. 11 is a chart illustrating flow of manufacturing the sleeve 221. In the manufacture of the sleeve 221, as illustrated in the cross sectional view of FIG. 12, powder material serving as raw material is first pressed by a forming device 71 to form a sleeve member 8 which is to be made into the sleeve 221.

The forming device 71 includes a upper punch 711 for pressing the powder material from an upper side, a lower punch 712 for pressing the powder material from a lower side, a die 713 for surrounding an outer surface (corresponding to the outer surface 2211 of the sleeve 221) of the powder material, and a core rod 714 to be inserted into an inner surface (corresponding to the inner surface 2212 of the sleeve 221) of the powder material. A cylindrical space 715 is formed by the die 713, the core rod 714 and the lower punch 712.

After the space 715 is filled with the powder material, the upper punch 711 is inserted into the space 715 from the upper side, and the powder material is pressed in a mold and is formed into the sleeve member 8 in a substantially cylindrical shape (step S31).

The sleeve member 8 thus pressed and formed is taken out of the forming device 71 and brought into a heating device, in which the sleeve member 8 is heated at high temperature and is sintered (step S32).

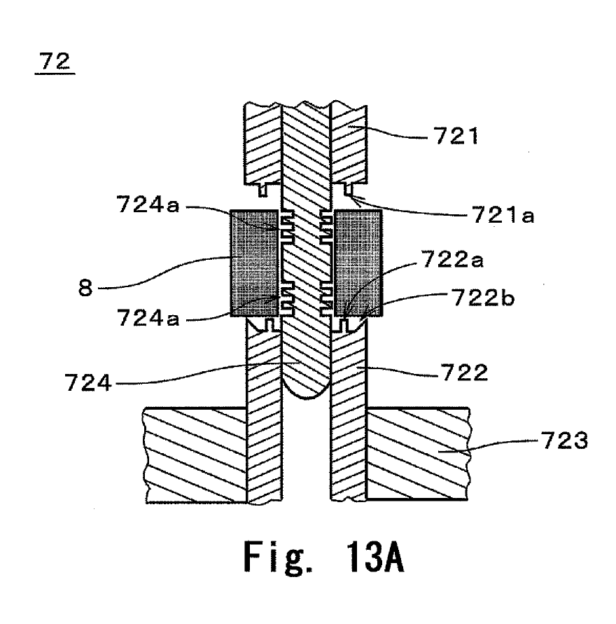

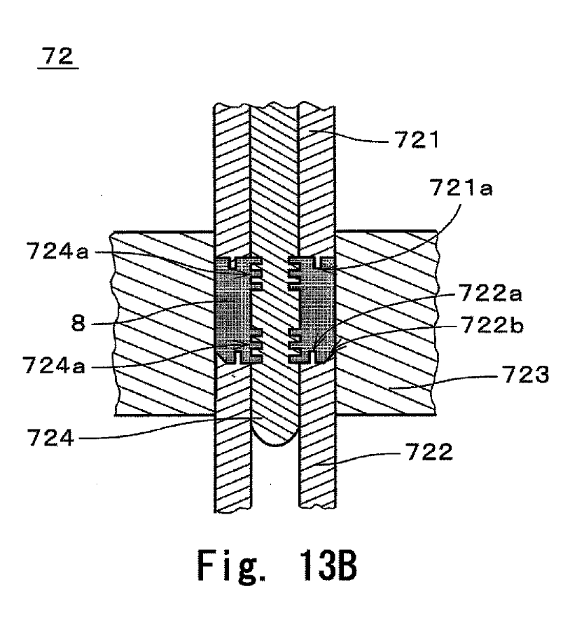

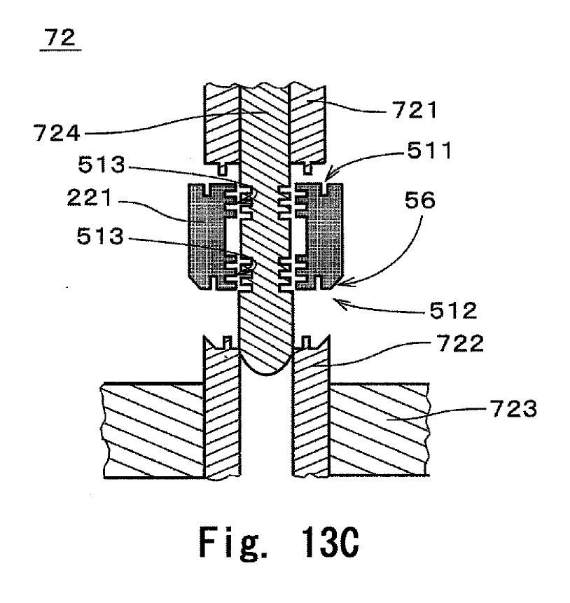

FIGS. 13A to 13C are views illustrating that the sintered sleeve member 8 is again pressed and sized by a sizing device 72. The sizing device 72 has a structure similar to that of the forming device 71, and includes an upper punch 721 for pressing the sleeve member 8 from an upper side, a lower punch 722 for pressing the sleeve member 8 from a lower side, a die 723 for binding an outer surface of the sleeve member 8, and a core rod 724 to be inserted into the sleeve member 8.

A lower surface of the upper punch 721 is provided with convexes 721a for forming the dynamic pressure grooves on an upper surface of the sleeve member 8, and an upper surface of the lower punch 722 is provided with convexes 722a for forming the dynamic pressure grooves on a lower surface of the sleeve member 8. An outer edge of the upper surface of the lower punch 722 is additionally provided with a circular convex portion 722b for forming the adhesive holding portion 56 (see FIG. 3B) of the sleeve 221. Further, while not illustrated in FIGS. 13A to 13C, the upper punch 721 and the lower punch 722 are provided with circular convex portions for forming chamfered shapes at other corners of the sleeve 221. An outer peripheral surface of the core rod 724 is provided with concaves 724a for forming the dynamic pressure grooves on an inner surface of the sleeve member 8.

As illustrated in FIG. 13A, in a state before the sleeve member 8 is inserted into the die 723, an inner diameter of the sleeve member 8 is larger than an outer shape of the core rod 724, and an outer shape of the sleeve member 8 is larger than an inner diameter of the die 723. The sleeve member 8 is sandwiched and held between the upper punch 721 and the lower punch 722.

As illustrated in FIG. 13B, the sleeve member 8 is pushed into the die 723 by the upper punch 721 (an entrance of the die 723 is formed with a taper for press fitting). Thus, the sleeve member 8 is compressed inwards by the die 723, and the concaves 724a on the core rod 724 are transferred onto the inner surface of the sleeve member 8. Further, the sleeve member 8 is pressed by the upper punch 721 and the lower punch 722, so that the convexes 721a on the upper punch 721 are transferred onto the upper surface of the sleeve member 8 and the convexes 722a and the circular convex portion 722b on the lower punch 722 are transferred onto the lower surface of the sleeve member 8.

FIG. 13C is a view illustrating that the sleeve member 8 is taken out of the sizing device 72 as the sleeve 221. The sleeve member 8 is expanded outwards as much as elastically deformed, and becomes separable from the core rod 724. A plastic deformation volume when compressed and an elastic deformation volume when released (so called springback volume) for the sleeve member 8 are predetermined, and the sleeve member 8 taken out of the sizing device 72 is turned into the sleeve 221 of a desired dimension (step S33). That is, the sizing device 72 simultaneously performs press sizing of the sleeve member 8, formation of the dynamic pressure grooves 511 and 512 on the both end surfaces in the central axis direction, formation of the dynamic pressure grooves 513 on the inner surface, and formation of the adhesive holding portion 56. Further, the chamfered shapes at the other corners are simultaneously formed.

In a case where the dynamic pressure grooves and the adhesive holding portion 56 are individually formed, it is required, after taking the sleeve member 8 out of a device for forming the dynamic pressure grooves, to load the sleeve member 8 onto a subsequent device for forming the adhesive holding portion 56 while confirming vertical orientation of the sleeve member 8. To the contrary, in the sizing device 72 of FIG. 13A, the sleeve member 8 can be loaded onto the sizing device 72 without distinguishing the vertical orientation of the sleeve member 8, thereby facilitating the manufacture of the sleeve 221 and reducing manufacturing cost. Moreover, since the sizing device 72 can simultaneously perform sizing and formation of grooves, reduction in manufacturing cost and increase in production speed can be realized in comparison to the case of performing these processes respectively in separate devices.

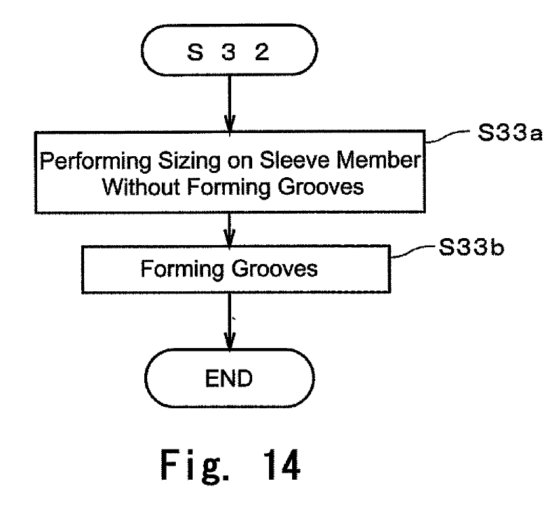

FIG. 14 is a chart illustrating another example of step S33 in FIG. 11. In the manufacturing step illustrated in FIG. 14, after being sintered, the sleeve member 8 is sized in the sizing device without the dynamic pressure grooves and the adhesive holding portion 56 being formed (step S33a). Accordingly, such a sizing device is obtained by eliminating the convexes 721a, convexes 722a, concaves 724a, and the circular convex portion 722b from that illustrated in FIG. 13A.

On completion of sizing, the sleeve member 8 is attached to a groove forming device having a structure similar to that of the sizing device 72 illustrated in FIG. 13A, and the entire sleeve member 8 is elastically deformed as well as partially plastically deformed to form the thrust and radial dynamic pressure grooves 511, 512, and 513 and the adhesive holding portion 56 (step S33b). Alternatively, certain sizing may be performed in step S33b, and step S33a may be regarded as main sizing included in sizing in steps S33a and S33b.

The technique of separately performing sizing and formation of the dynamic pressure grooves as illustrated in FIG. 14 is adopted when the sleeve 221 is not sufficiently accurately formed by simultaneously performing sizing and formation of the dynamic pressure grooves. Since the dynamic pressure grooves and the adhesive holding portion 56 are simultaneously formed also in the manufacturing process illustrated in FIG. 14, the sleeve member 8 can be handled without distinction of the vertical relation until reaching the device for forming the dynamic pressure grooves, realizing reduction in manufacturing cost.

While the embodiment of the present invention has been thus described, the present invention is not limited thereto but can be modified in various ways.

For example, while the sleeve 221 and the sleeve housing 222 are held after the adhesive 220 is applied thereto in the above embodiment, application of the adhesive can be performed after the sleeve 221 and the sleeve housing 222 are held. The order of holding the sleeve and holding the sleeve housing may also be appropriately altered.

Moreover, the adhesive holding portion 56 is not limitedly formed as a surface having a cross section including one straight line or a plurality of straight lines continuous with one another, but may be formed as a surface having a cross section including a curved line. In addition, the chamfered shapes at the outer and inner peripheral edges of the first end part and the inner peripheral edge of the second end part may have cross sections including curved lines.

In manufacture of the sleeve 221, formation of the chamfered shapes and the adhesive holding portion 56 of the sleeve 221 (the sleeve member 8 to be precise) may be performed in the forming step. In the forming step, the adhesive holding portion 56 can be easily formed while causing no remaining stress within the sleeve member 8. Alternatively, the adhesive holding portion 56 may be formed in the sizing step (step S33a) not including formation of the dynamic pressure grooves.

The motor according to the above described embodiments is not necessarily of an inner rotor type in which the rotor magnet 32 is arranged radially inside with respect to the armature 24, but may be of an outer rotor type in which the rotor magnet 32 is arranged radially outside the armature 24. Further, the bearing assembly may adopt, for example, so called a gas dynamic pressure bearing in which air is utilized as fluid.

The motor according to the above described embodiments may also be used as a drive source of a device other than a hard disk device (for example, a disk drive device such as a removable disk device).

What is claimed is:

1. A method of manufacturing a sleeve unit including a sleeve and a sleeve housing,
the sleeve has a substantially cylindrical body centered on a center axis and includes an axially first side end surface and an axially second side end surface, and
the sleeve housing has a substantially cylindrical body in which the sleeve is accommodated,
the method comprising steps of:
(a) applying an adhesive to a portion of an inner surface of the sleeve housing, which is to radially oppose an outer surface of the sleeve in the sleeve unit; and
(b) inserting the sleeve into the sleeve housing from the axially first side end surface of the sleeve along an axial direction,
wherein
an outer diameter of the sleeve is approximate to an inner diameter of the sleeve housing,
the sleeve includes a first connecting surface connecting the axially first end side surface and the outer surface of the sleeve, an outer diameter of the axially first side surface is smaller than a diameter of the outer surface of the sleeve,
a portion of the adhesive is spread along the inner surface of the sleeve housing, and the other portion of the adhesive is held on the first connecting surface and between the first connecting surface and the inner surface of the sleeve housing in the step (b).

2. The method as set forth in claim 1, wherein the other portion of the adhesive is held on the first connecting surface and between the first connecting surface and the inner surface of the sleeve housing without axially protruding from the axially first side end surface of the sleeve.

3. The method as set forth in claim 1, wherein the sleeve includes a second connecting surface connecting the outer surface of the sleeve and the axially second side end surface, a width in the radial direction of the first connecting surface is greater than that of the first connecting surface.

4. The method as set forth in claim 1, wherein the sleeve includes a first thrust bearing portion arranged in the axially first side end surface and a second thrust bearing portion arranged in the axially second side end surface.

5. The method as set forth in claim 4, wherein the first thrust bearing portion includes a plurality of dynamic pressure generating grooves arrayed in a spiral shape, and the second thrust bearing portion includes a plurality of dynamic pressure generating grooves arrayed in a herringbone shape.

6. The method as set forth in claim 1, wherein the adhesive is anaerobic ultraviolet curable and a step of radiating ultraviolet to the other portion of the adhesive held on the first connecting surface is performed after the step (b).

7. The method as set forth in claim 1, wherein the sleeve is porous and is formed by pressing powder material.

8. The method as set forth in claim 7, the method further comprising steps of:
(I) pressing the powder material in a mold and forming a sleeve member having a substantially cylindrical shape;
(II) heating and sintering the sleeve member; and
(III) pressing and sizing the sleeve member to obtain the sleeve, wherein
in the step (III) includes the substeps of:
forming a first thrust bearing portion in the axially first side end surface and a second thrust bearing portion in a axially second side end surface; and
forming the first connecting surface, and a second connecting surface connecting the outer surface and the axially second side end surface having an outer diameter smaller than that of the outer surface, and
a width in the radial direction of the first connecting surface is greater than that of the second connecting surface.

9. The method as set forth in claim 8, wherein the first thrust bearing portion, the second bearing portion, and the second connecting surface are concurrently formed in the same substep.

10. The method as set forth in claim 1, wherein
the first connecting surface includes a first inclined surface which has an annular shape and connected to the radially outer surface of the sleeve, and a second inclined surface which has an annular shape and connected to a radially inner end of the first inclined surface, and
in a cross section of the sleeve along the center axis, a first obtuse angle defined between the radially outer surface of the sleeve and the first inclined surface is greater than a second obtuse angle defined between the first inclined surface and the second inclined surface.

11. A method of manufacturing a sleeve unit including a sleeve and a sleeve housing,
the sleeve has a substantially cylindrical body centered on a center axis and includes an axially first side end surface and an axially second side end surface, and
the sleeve housing has a substantially cylindrical body in which the sleeve is accommodated,
the method comprising steps of:
(a) applying an adhesive to a portion of an outer surface of the sleeve, which is to radially oppose an inner surface of the sleeve housing in the sleeve unit; and
(b) inserting the sleeve into the sleeve housing from the axially second side end surface of the sleeve along an axial direction,
wherein
an outer diameter of the sleeve is approximate to an inner diameter of the sleeve housing,
the sleeve includes a first connecting surface connecting the axially first end side surface and the outer surface of the sleeve, an outer diameter of the axially first side surface is smaller than a diameter of the outer surface of the sleeve,
a portion of the adhesive is spread along the inner surface of the sleeve housing, and the other portion of the adhesive is held on the first connecting surface and between the first connecting surface and the inner surface of the sleeve housing in the step (b).

12. The method as set forth in claim 1, wherein the other portion of the adhesive is held on the first connecting surface and between the first connecting surface and the inner surface of the sleeve housing without axially protruding from the axially first side end surface of the sleeve.

13. The method as set forth in claim 11, wherein the sleeve includes a second connecting surface connecting the outer surface of the sleeve and the axially second side end surface, a width in the radial direction of the first connecting surface is greater than that of the second connecting surface.

14. The method as set forth in claim 11, wherein the sleeve includes a first thrust bearing portion arranged in the axially first side end surface and a second thrust bearing portion arranged in the axially second side end surface.

15. The method as set forth in claim 14, wherein the first thrust bearing portion includes a plurality of dynamic pressure generating grooves arrayed in a spiral shape, and the second thrust bearing portion includes a plurality of dynamic pressure generating grooves arrayed in a herringbone shape.

16. The method as set forth in claim 11, wherein the adhesive is anaerobic ultraviolet curable and a step of radiating ultraviolet to the other portion of the adhesive held on the first connecting surface and between the first connecting surface and the inner surface of the sleeve housing is performed after the step (b).

17. The method as set forth in claim 11, wherein the sleeve is porous and is formed by pressing powder material.

18. The method as set forth in claim 17, the method further comprising steps of:
(I) pressing powder material in a mold and forming a sleeve member having a substantially cylindrical shape;
(II) heating and sintering the sleeve member; and
(III) pressing and sizing the sleeve member to obtain the sleeve, wherein
in the step (III) includes the substeps of:
forming a first thrust bearing portion in the axially first side end surface and a second thrust bearing portion in a axially second side end surface; and
forming the first connecting surface, and a second connecting surface connecting the outer surface and the axially second side end surface having an outer diameter smaller than that of the outer surface, and
a width in the radial direction of the first connecting surface is smaller than that of the second connecting surface.

19. The method as set forth in claim 18, wherein the first thrust bearing portion, the second bearing portion, and the second connecting surface are concurrently formed in the same substep.

20. The method as set forth in claim 11, wherein
the first connecting surface includes a first inclined surface which has an annular shape and connected to the radially outer surface of the sleeve, and a second inclined surface which has an annular shape and connected to a radially inner end of the first inclined surface, and
in a cross section of the sleeve along the center axis, a first obtuse angle defined between the radially outer surface of the sleeve and the first inclined surface is greater than a second obtuse angle defined between the first inclined surface and the second inclined surface.

21. A sleeve unit used for a motor having a rotor hub rotatable about the center axis, comprising:
a sleeve having a cylindrical shape and including
an axially first side end surface arranged in an axially first side,
an axially second side end surface arranged in an axially second side which is an axially opposite side of the axially first side,
a first connecting surface connecting an outer surface and the first axial surface having an outer diameter smaller than that of the outer surface, and
a second connecting surface connecting the outer surface and the second axial surface having an outer diameter smaller than that of the outer surface;
a sleeve housing accommodating the sleeve and having an inner surface to which the outer surface of the sleeve is attached; and
an adhesive a portion of which is arranged between the inner surface of the sleeve housing and the outer surface of the sleeve, wherein
an adhesive holding portion is defined between the first connecting surface and the inner surface of the sleeve housing, and
a portion of the adhesive is held in the adhesive holding portion.

22. The sleeve unit as set forth in claim 21, wherein the portion of the adhesive is held in the adhesive holding portion without axially protruding from the axially first side end surface of the sleeve.

23. The sleeve unit as set forth in claim 21, wherein a width in the radial direction of the first connecting surface is greater than that of the second connecting surface.

24. The sleeve unit as set forth in claim 21, wherein the sleeve includes a first thrust bearing portion arranged in the axially first side end surface and a second thrust bearing portion arranged in the axially second side end surface.

25. The sleeve unit as set forth in claim 24, wherein the first thrust bearing portion includes a plurality of dynamic pressure generating grooves arrayed in a spiral shape, and the second thrust bearing portion includes a plurality of dynamic pressure generating grooves arrayed in a herringbone shape.

26. A motor comprising:
a stationary portion including,
a base plate,
the sleeve unit as set forth in claim 21 and arranged on the base plate,
an armature arranged on the base plate,
a first dynamic pressure generating groove array having a plurality of dynamic grooves and arranged in the axially first side end surface of the sleeve,
a second dynamic pressure generating groove array having a plurality of dynamic pressure generating grooves and arranged in the axially second side end surface of the sleeve; and
a rotor portion rotatable relative to the stationary portion about a center axis and including,
a rotor hub,
a shaft attached to the rotor hub and inserted into the sleeve of the sleeve unit, and
a rotor magnet attached to the rotor hub and radially facing the armature via a gap defined therebetween; and
a lubricating oil impregnated in the sleeve and filling micro-gaps between the shaft and the sleeve, and between the sleeve and the rotor hub,
wherein
the axially second side end surface axially opposes a portion of the rotor hub via a gap defined therebetween which is filled with the lubricating oil, and
the axially second side end surface, the second dynamic pressure generating groove array, the portion of the rotor hub, and the lubricating oil filling the gap define a thrust dynamic pressure bearing.
